(19) United States
(12) Patent Application Publication
(10) Pub. No.: US 2003/0085546 A1
(43) Pub. Date: May 8, 2003

(54) Pivoting platform for motorcycles

(76) Inventor: Louis P. Aussant, Calgary (CA)

Correspondence Address: THOMAS E. MALYSZKO, PATENT & TRADE MARK AGENT, Suite 1500, 250-6th Ave. S.W., Calgary, AB, T2P 3H7, CA

(21) Appl. No.: 09/985,213

(22) Filed: Nov. 2, 2001

(51) Int. Cl. B62H 1/00

(52) U.S. Cl. 280/293; 280/29

(57) ABSTRACT

A device for supporting a motorcycle is provided having a planar platform with a top surface for receiving the motorcycle in an upright position. A number of wheels mounted at selected locations of the platform protrude below the platform for support and rolling the platform on a ground surface, such as a concrete floor in a garage. An anchor at the front end of the platform bolts into the ground surface for pivoting the platform over the ground surface. A locking mechanism is provided near the rear end of the platform for selectively engaging the ground surface to keep the platform from pivoting.

### FIELD OF THE INVENTION

The present invention relates to moveable supports for objects such as motor vehicles, and in particular to a support platform for motorcycles.

### BACKGROUND OF INVENTION

It is often difficult and frustrating to maneuver a motorcycle into and about the tight confines of a garage, particularly when the garage space is occupied by an automobile. Typically the automobile is first moved out of the garage, and then the motorcycle is wheeled in and moved to and fro to place it beside the garage wall to minimize obstruction of the garage space. Such manipulation wastes time, effort and energy, particularly for larger and heavier motorcycles. If the automobile is not moved out first, then it can be scratched as the motorcycle is maneuvered about.

What is therefore desired is a novel device for supporting a motorcycle in an upright position and for easily moving the motorcycle into and out of a stored position in a confined area, such as a garage.

### SUMMARY OF THE INVENTION

A device for supporting a motorcycle comprises a substantially planar platform having a top surface for receiving said motorcycle thereon, an opposed bottom surface, and opposed front and rear edges;

a plurality of wheels mounted at selected locations of the platform and protruding below the bottom surface to movably support said platform on a ground surface in a spaced relationship;

an anchor means for fixing to the ground surface and for rotatably engaging the platform proximate the front edge for pivoting the platform thereabout over the ground surface; and,

a locking mechanism mounted to the platform for selectively engaging the ground surface to prevent the pivoting of the platform.

### BRIEF DESCRIPTION OF THE DRAWING FIGURES

Embodiments of the invention will now be described, by way of example only, with reference to the accompanying drawings, wherein:

FIG. 1 is a top plan view of a pivoting platform for a motorcycle according to a preferred embodiment of the present invention, showing in ghost outline the general location of the front and rear wheels 11 and 10, respectively, of a motorcycle 9 stationed on the platform 1, and the general locations of a centrestand 8 or kickstand 7, depending on the make of the motorcycle;

FIG. 2 is a side view of the platform of FIG. 1 showing a bottom part of the motorcycle stationed thereon;

FIG. 3 is an end view from the left of FIG. 2 showing a motorcycle supported with a kickstand, and showing platform support wheels 4 in partial ghost outline;

FIG. 4 is a view similar to FIG. 3 showing a motorcycle supported with a center stand;

FIG. 5 is an isolated close-up plan view of an opening in the platform 1 for housing a platform support wheel 4 and respective axle 13;

FIG. 6 is close-up side view of the wheel 4 within the opening of FIG. 5 for supporting the platform 1;

FIG. 7 is a detailed side view of a pivot 2 at the front end of the platform employing a bolt anchor assembly 21 mountable to the concrete floor;

FIG. 8 is a close-up side view of an optional wall mounted bracket 3 which may be used in place of the bolt anchor of FIG. 7 for fixing the location of the pivot 2 relative to the wall 16 without puncturing the concrete floor 14;

FIG. 9 is a top plan view of the bracket 3 with several holes 15 for selectively fixing the location of the platform's pivot 2 relative to the wall 16 with a nut and bolt arrangement 17; and,

FIG. 10 shows, in plan view, several selected positions of the platform relative to the garage wall 16 when swiveled about the pivot 2.

### DECRIPTION OF PREFERRED EMBODIMENTS

The figures show a pivoting platform device 1 used to facilitate parking, storing, maneuvering and/or servicing of a motorcycle 9. The platform 1 will also be referred to herein as a “motoswivel”. The motorcycle 9 can be easily ridden onto (or pushed onto) the platform and parked thereon (with either the kickstand 7 or the center stand 8 employed, depending on the make of the motorcycle), and then “swiveled” into the desired position with very little effort. The motoswivel allows better usage of space in a garage. The device allows for a wide range of motion (up to a full 360 degrees) depending on its location within the garage, in particular its distance from any garage wall 16.

In one embodiment the pivoting parking platform 1 is mounted to a concrete garage floor 14, or “bearing surface”, near the front end of the unit (i.e. at a pivoting point 2) with the use of a threaded insert/bolt anchor assembly 21 set into the concrete floor 14 (typical installation shown—FIG. 7). In another embodiment (FIGS. 8 and 9), the anchor assembly 21 may be replaced with a wall bracket 3 mountable to the garage wall 16, where penetration of the concrete floor 14 is not desired. The bracket 3 has several holes 15 for selectively fixing the location of the platform's pivot 2 relative to the wall 16 with a nut and bolt arrangement 17. A void 31 may be provided in the bracket 3 to reduce weight and material usage.

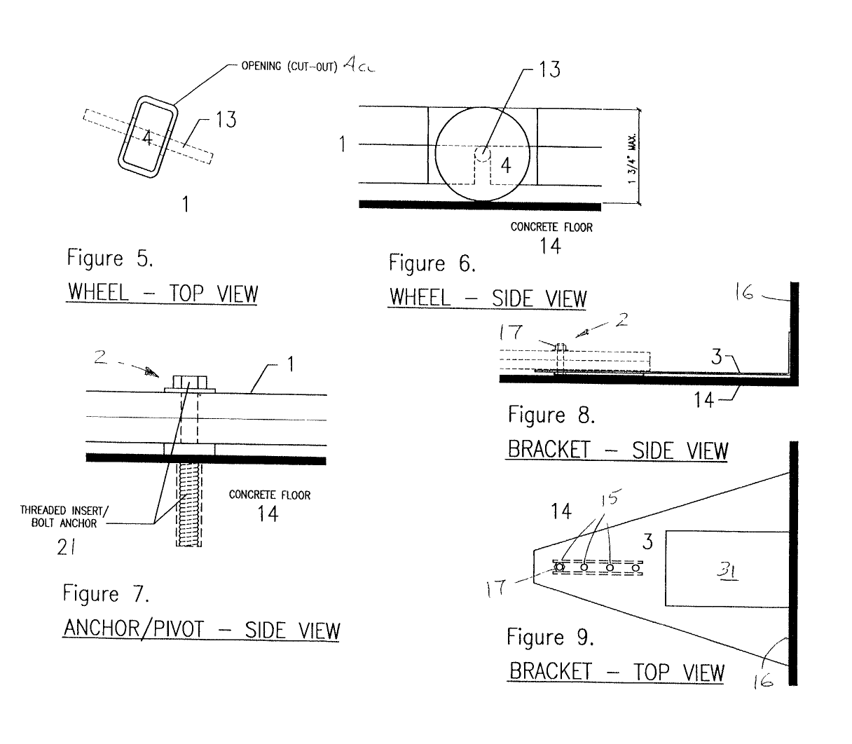

The platform's “swivel” action is achieved with the use of ball bearing wheels 4 mounted on steel axles 13 which are placed at strategic locations throughout the platform to allow all production motorcycles to be accommodated. The wheels 4 and axles 13 are mounted within the plane of the platform in openings 4a, or “cut-outs”, to reduce the overall height of the motoswivel (FIGS. 5 & 6). The 1½″ thick platform 1 is positioned only 1¾″ above the floor thus eliminating the need for a ramp and making it easy to negotiate for riders of all sizes and all skill levels. The 8 foot long platform 1 is capable of supporting up to 1000 lbs.—allowing the largest of production motorcycles to be parked and maneuvered on it.

An optional wheel stop 5 is located at the front of the parking platform 1 to allow for consistent placement/parking of the motorcycle 9 and to avoid the motorcycle being driven beyond the front of the platform.

A non-slip top parking surface of the parking platform 1 is resistant to most chemicals, grease, and oil (all associated with motorcycle care and maintenance).

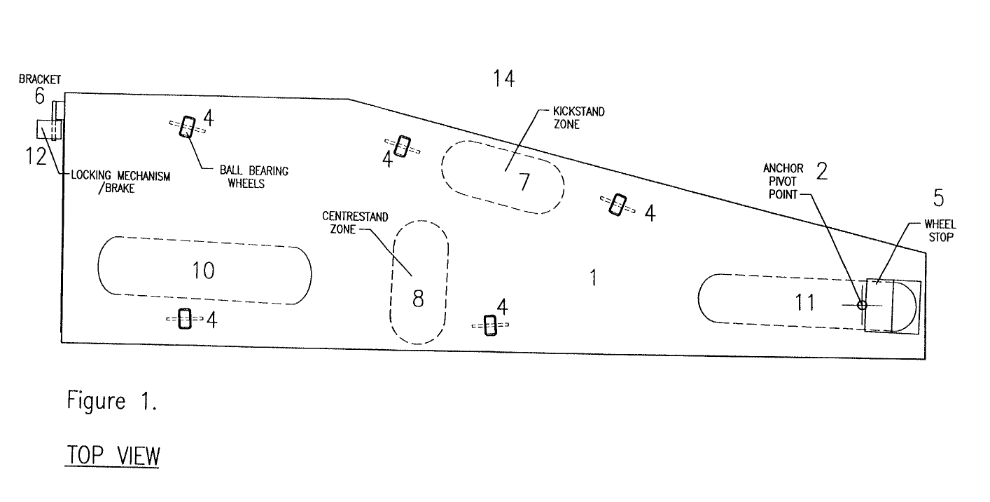

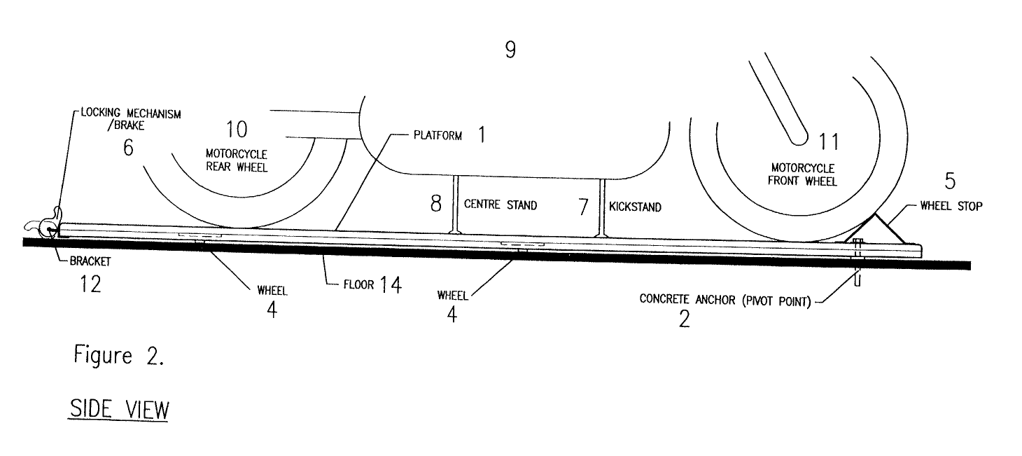

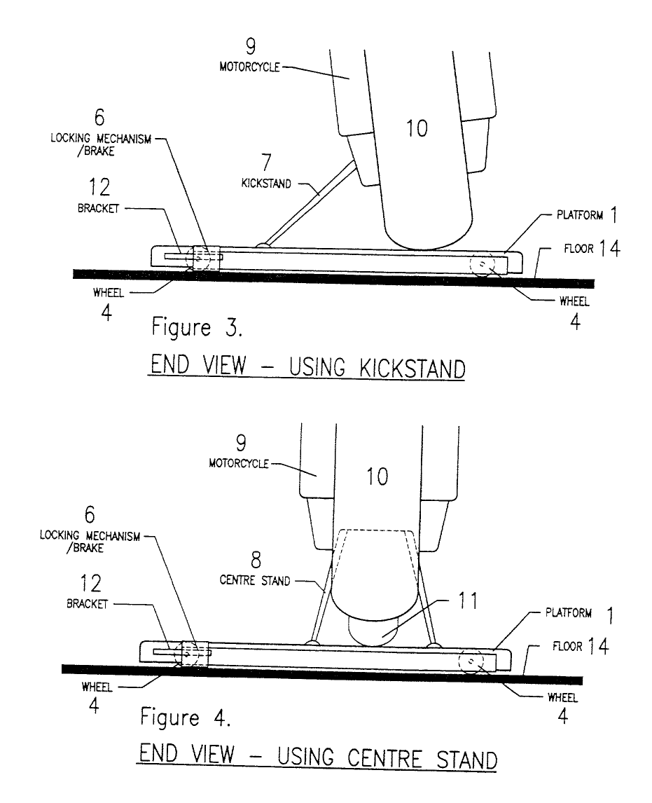

The motoswivel platform 1 is equipped with a locking mechanism 6 (the “brake”—FIGS. 1-4) which prevents the platform 1 from “washing” out from under the rider/motorcycle when riding onto the platform, riding off of the platform, and mounting or dismounting the motorcycle 9. The brake 6, made of polyurethane or other suitable non-slip material mounted on a metal bracket 12, is lowered into contact with the concrete floor 14 to resist swiveling of the platform, and is lifted out of contact with the floor when swiveling is desired. The brake 6 may be biased for positive contact with and/or away from the floor. The brake is designed for easy and maintenance-free use.

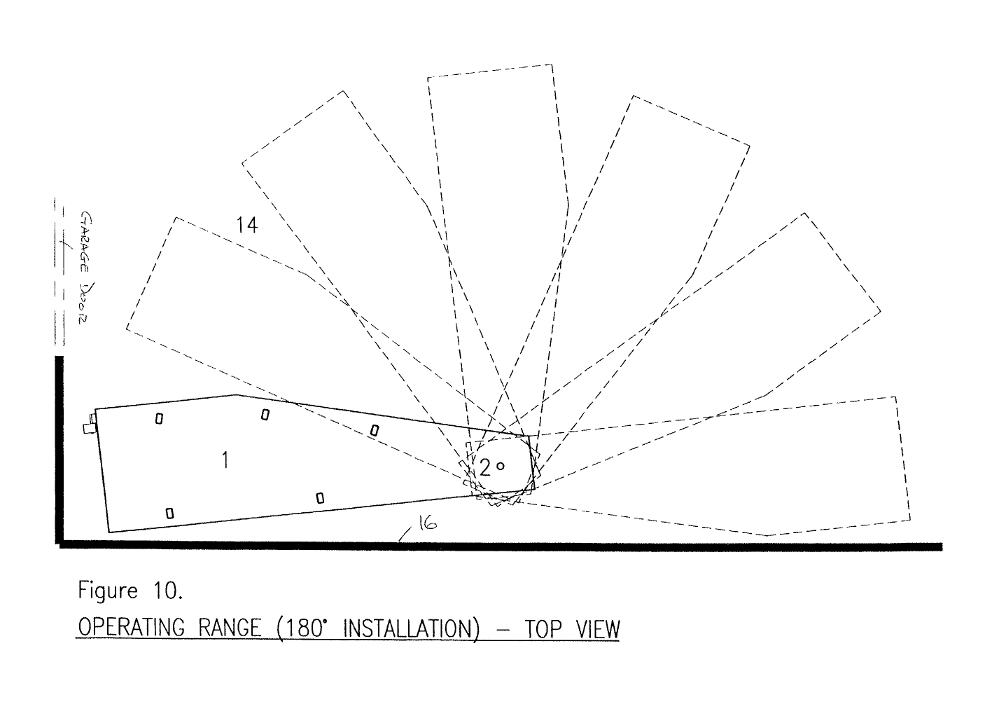

The motoswivel allows a motorcycle 9 to be parked in most residential garages without the need of removing a vehicle from the garage to make space for entrance/removal of the motorcycle. In use, a user must merely “swivel” the platform 1 out from the wall 16 (i.e. from its “stored position”) to clear the garage door and the vehicle, apply the brake 6, ride or push the motorcycle 9 onto the platform 1, set the kickstand 7 or centrestand 8, disengage the brake 6, “swivel” the platform along with the motorcycle thereon toward the wall to a desired “stored position”, and re-apply the brake 6. These steps are taken in reverse to remove the motorcycle. If servicing the motorcycle, the motoswivel can be easily “swiveled” into a position allowing full access to both sides of the motorcycle, as shown in FIG. 10.

Since most motorcycles have a kickstand 7 mounted on the left side, the motorcycle 9 leans to the left when parked. The shape of the motoswivel platform 1 is tapered outwardly from front to back in order to accommodate the motorcycle's rear wheel 10, front wheel 11, and kickstand 7 or centrestand 8, while minimizing the space requirements of the platform on the garage floor.

Some of the many advantages of the present invention may now be better appreciated:

The platform 1 footprint (i.e. dimension and shape) maximizes manufacturing efficiency (i.e. 2 platforms may be cut from a standard 4′×8′ sheet of plywood);

In a preferred version, the platform 1 is constructed of 1½″ thick laminated wood for maximum strength and durability while maintaining minimal thickness to facilitate movement of the motorcycle onto and off the platform;

The threaded insert anchor/bolt 21 allows for easy detachment of the platform from the floor for storage (in the off-season) if required;

The ball-bearing wheels 4 allow for smooth maneuverability over the floor and trouble-free operation;

The slip-resistant surface of the platform provides desired traction for safety; and,

The platform's slim design allows for maximum circulation space around a motorcycle parked thereon while minimizing lost space on the garage floor.

The above description is intended in an illustrative rather than a restrictive sense, and variations to the specific configurations described may be apparent to skilled persons in adapting the present invention to other specific applications. Such variations are intended to form part of the present invention insofar as they are within the spirit and scope of the claims below.

I claim:

1. A device for supporting a motorcycle comprising:
a substantially planar platform having a top surface for receiving said motorcycle thereon, an opposed bottom surface, and opposed front and rear edges;
a plurality of wheels mounted at selected locations of said platform and protruding below said bottom surface to movably support said platform on a ground surface in a spaced relationship;
an anchor means for fixing to said ground surface and for rotatably engaging said platform proximate said front edge for pivoting said platform thereabout over said ground surface; and,
a locking mechanism mounted to said platform for selectively engaging said ground surface to prevent said pivoting of said platform.
